(19) United States
(12) Patent Application Publication
(10) Pub. No.: US 2015/0224676 A1
(43) Pub. Date: Aug. 13, 2015

(54) System and Method for Articulated Impingement Mold Heating

(71) Applicants: Robert M. Davies, Atlanta, TX (US); Joe Frank Harrison, III, Atlanta, TX (US)

(72) Inventors: Robert M. Davies, Atlanta, TX (US); Joe Frank Harrison, III, Atlanta, TX (US)

(21) Appl. No.: 14/619,805

(22) Filed: Feb. 11, 2015

Related U.S. Application Data
(60) Provisional application No. 61/938,211, filed on Feb. 11, 2014.

(51) Int. Cl. B29C 33/04; B29C 33/38

(52) U.S. Cl. CPC B29C 33/04; B29C 33/3828; B29C 2035/1616

(57) ABSTRACT

A system and method for articulated impingement mold heating utilizes a reduced mass mold having a first open-back mold half and a second open-back mold half. A preform is loaded into a mold cavity delineated by a first cavity shell of the first open-back mold half and a second cavity shell of the second open-back mold half. An outer shell surface of both the first cavity shell and the second cavity shell is then heated using an at least one heating nozzle following a heating path. The first open-back mold half and the second open-back mold half are pressed together and a cooling mechanism is utilized to cool the reduced mass mold; the cooling mechanism being an at least one cooling nozzle following a cooling path or an at least one cooling plug. Once cooled, a molded piece shaped from the preform is removed from the mold cavity.

The current application claims a priority to the U.S. Provisional Patent application Ser. No. 61/938,211 filed on Feb. 11, 2014.

### FIELD OF THE INVENTION

The present invention relates generally to a system and method for heating and cooling molds for molding plastics, plastic composites, and other applications where rapid thermal cycling is critical to the process.

### BACKGROUND OF THE INVENTION

Molds typically have at least two halves. The two halves mate with each other along what is known in the industry as a parting line. When in the closed condition, a cavity is defined by the space between the two halves. This cavity area represents space in which the product is to be molded from a re-formable material such as polymer resin or ceramic slurry. Rapid heating and cooling of injection or compression molds is constrained because they are typically made from large solid steel blocks that are required to withstand the stress placed on the mold from the required pressing forces and injection pressures. These molds have large thermal mass which requires a great deal of energy to heat, and conversely a large amount of heat must be removed to cool the mold, therein requiring a substantial amount of time to carry out either operation.

The molding of plastics and plastic composites generally requires the mold to be heated and cooled to facilitate the molding process and conditions. The dominant systems used today for thermal cycling of molds use water, steam, or oil circulation or electric resistance heaters such as cartridge heaters. Induction heating of the molds and mold surfaces has also been tried but it needs another medium such as water to cool the molds and is very expensive. To shorten the thermal cycle, many have added more heat input into the transfer mediums such as oil, but the available temperature delta of the oils and thermal transfer efficiency to the mold limit the success of this. Another method is increasing the wattage and the number of electric heating elements in the mold. The mass of the surrounding mold is great which demands high energy to heat and this inhibits rapid thermal cycling. Also the temperature gradient between the heaters is large and unacceptable in many applications. Impingement heating the back surface of a thin mold face with a hot fluid or gas has also been practiced but the temperature of the heated fluid, such as hot air, is limited and the impingement ports are stationary which focuses the heated fluid on a specific area of the mold which causes a temperature gradient between ports. In cases where rapid thermal cycling is required these systems are unable to deliver or remove energy rapidly.

Therefore it is the object of the present invention to provide a system and method for articulated impingement mold heating. A reduced mass mold having a first open-back mold half and a second open-back mold half is employed to shape a preform into a molded piece. The first open-back mold half has a first cavity shell being a thin walled structure, while the second open-back mold half has a second cavity shell also being a thin walled structure. At least one heating nozzle is used to apply heat to an outer shell surface of both the first cavity shell and the second cavity shell, wherein each of the at least one heat nozzle is articulated by a robot or motion control device. The reduced mass mold is then pressed and a cooling mechanism, such as an at least one cooling nozzle is used to cool the first cavity shell and the second cavity shell. Similar to the at least one heating nozzle, the at least one cooling nozzle is articulated about the reduced mass mold using a robot or motion control device.

### BRIEF DESCRIPTION OF THE DRAWINGS

FIG. 1 is a perspective view of the reduced mass mold showing the back side of the first open-back mold half.

FIG. 2 is a perspective view of the reduced mass mold showing the back side of the second open-back mold half.

FIG. 3 is a front sectional view of the reduced mass mold having sections of a thermal coating, and showing two dimensions of the heating/cooling path for the at least one nozzle assembly.

FIG. 4 is a side sectional view of the reduced mass mold divided into a plurality of zones, showing two dimensions of the heating/cooling path for the at least one nozzle assembly.

FIG. 5 is a front sectional view of the first open-back mold half having a thermal insert, and wherein the outer shell surface of the first cavity shell is textured.

FIG. 6 is a front sectional view of the second open-back mold half having a thermal insert, and wherein the outer shell surface of the second cavity shell is textured.

FIG. 7 is a perspective view of the reduced mass mold, wherein an at least one cooling plug is positioned into the first open-back mold half.

FIG. 8 is a diagram depicting the stations for carrying out the method of the present invention.

FIG. 9 is a flowchart depicting the steps for shaping a preform into a molded piece using the reduced mass mold;

FIG. 10 is a flowchart thereof, further depicting steps wherein the at least one heating nozzle is articulated to heat the reduced mass mold;

FIG. 11 is a flowchart thereof, further depicting steps wherein the reduced mass mold is articulated about the at least one heating nozzle;

FIG. 12 is a flowchart thereof, further depicting steps wherein the at least one cooling nozzle is articulated to cool the reduced mass mold;

FIG. 13 is a flowchart thereof, further depicting steps wherein the reduced mass mold is articulated about the at least one cooling nozzle; and

FIG. 14 is a flowchart thereof, further depicting steps wherein the at least one cooling plug is utilized to cool the reduced mass mold.

### DETAIL DESCRIPTIONS OF THE INVENTION

All illustrations of the drawings are for the purpose of describing selected versions of the present invention and are not intended to limit the scope of the present invention.

The present invention is a system and method for articulated impingement mold heating. The method of the present invention is for the heating of molds for making articles from plastics, resins, composites, ceramics, and cast metals or any other molding materials needing heat to melt or cure. The system of the present invention utilizes a reduced mass mold 10, an at least one heating nozzle 20, and a cooling mechanism 30. The reduced mass mold 10 is used to retain, heat, and shape a preform 50 that is to be formed into a molded piece 60. The at least one heating nozzle 20 and the cooling mechanism 30 are articulated and focused along the outer surface of the reduced mass mold 10 with the aid of a robot or motion control device. The motion of the robot or motion control device is programmed and deliberate as to provide uniform and repeatable heating and cooling of the reduced mass mold 10.

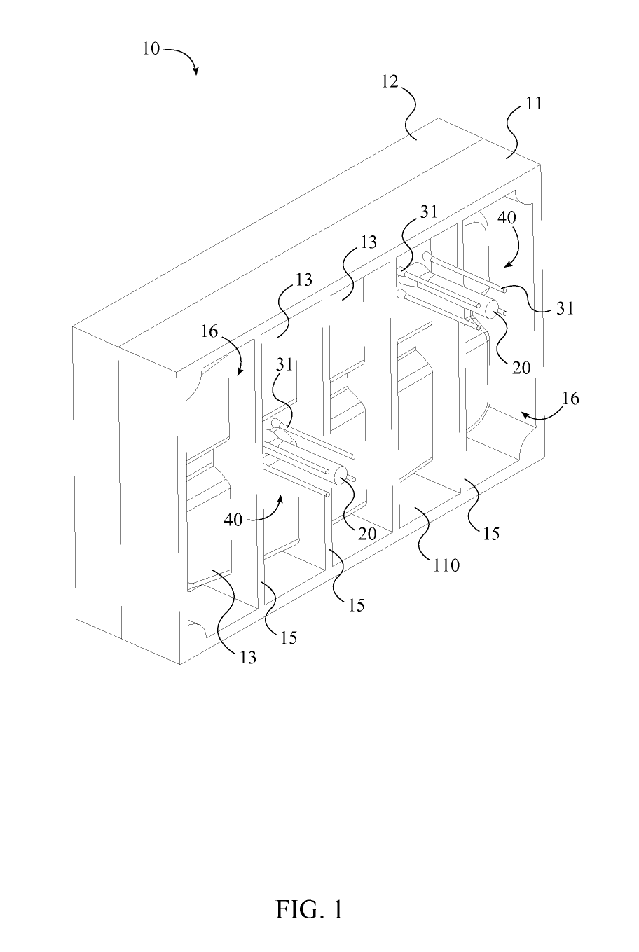

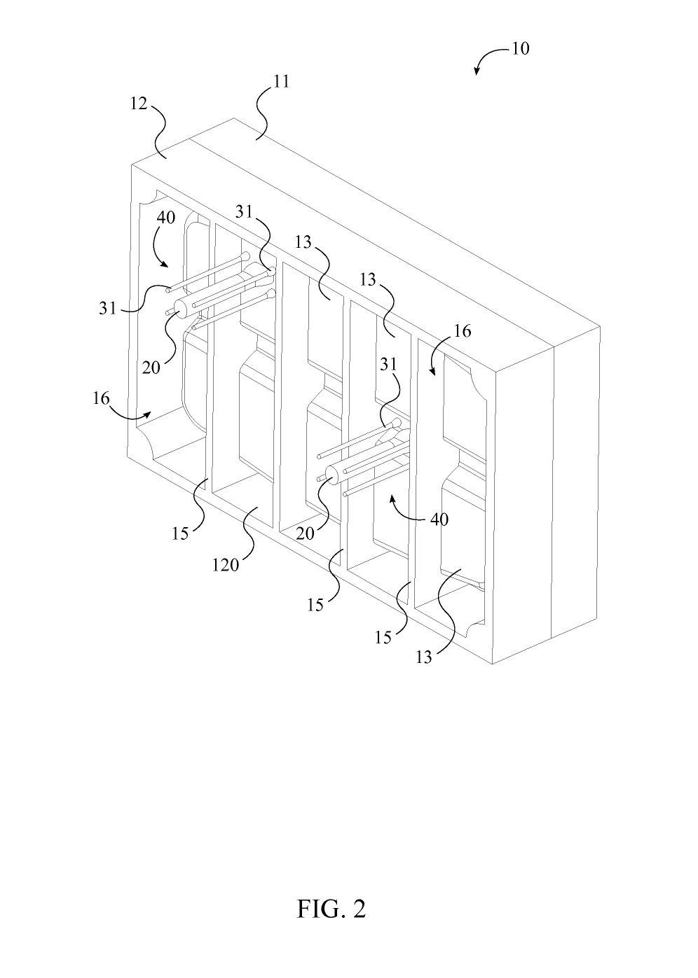

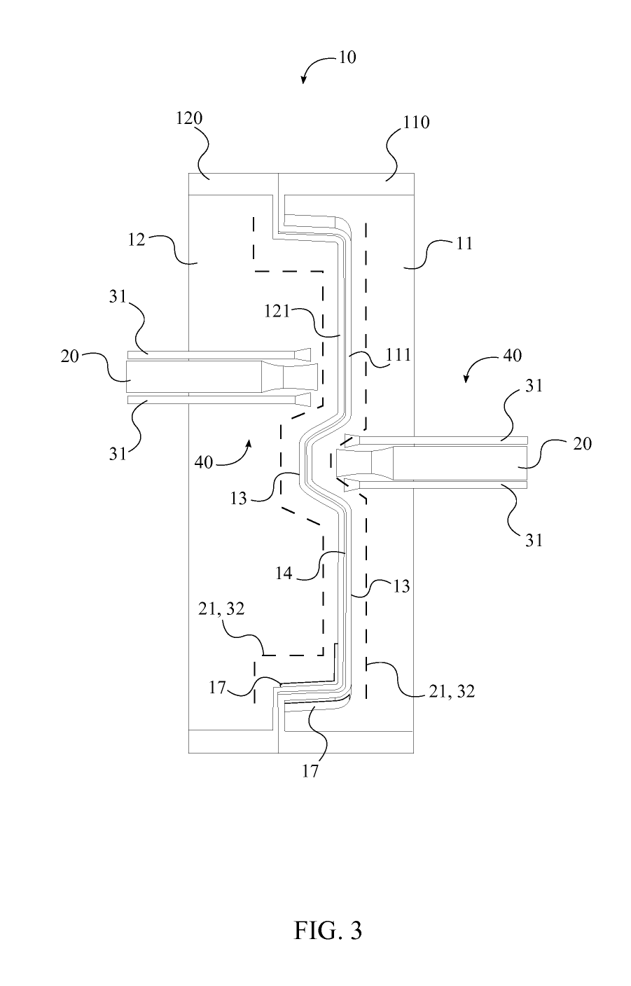

In reference to FIG. 1-2, the reduced mass mold 10 comprises a first open-back mold half 11 and a second open-back mold half 12, such that the reduced mass mold 10 may be split in half. The first open-back mold half 11 comprises a first lateral wall 110 perimetrically positioned around a first cavity shell 111, while the second open-back mold half 12 comprises a second lateral wall 120 perimetrically positioned around a second cavity shell 121. When in use, the first open-back mold half 11 is positioned adjacent to the second open-back mold half 12; more specifically, the first cavity shell 111 is positioned adjacent to the second cavity shell 121, wherein the first cavity shell 111 and the second cavity shell 121 delineate a mold cavity 14, as shown in FIG. 3, in which the preform 50 is placed. Both the first cavity wall and the second cavity wall comprise an outer shell surface 13 to which the at least one heating nozzle 20 and the cooling mechanism 30 are adjacently positioned in order to transfer thermal energy to and from the reduced mass mold 10.

In reference to FIG. 3, the first cavity shell 111 and the second cavity shell 121 are both thin walled structures, such that thermal energy can readily be transferred from the outer shell surface 13 to the preform 50 and vice versa. In the preferred embodiment of the present invention, the first cavity shell 111 and the second cavity shell 121 both have a uniform thickness for even thermal distribution about the first open-back mold half 11 and the second open-back mold half 12. However, it is also possible for the first cavity shell 111 or the second cavity shell 121 to be of uneven thickness in other embodiments of the present invention, depending on the application of the present invention and the requirements for heating the preform 50.

In reference to FIG. 1-2, the first lateral wall 110 is extruded from the first cavity shell 111 creating the open back structure of the first open-back mold half 11, wherein the outer shell surface 13 of the first cavity shell 111 is positioned about the first cavity shell 111 within the first lateral wall 110 opposite the cavity mold. Similarly, the second lateral wall 120 is extruded from the second cavity shell 121 creating the open back structure of the second open-back mold half 12, wherein the outer shell surface 13 of the second cavity shell 121 is positioned about the second cavity shell 121 within the second lateral wall 120 opposite the cavity mold. The reduction of the back sides of the first open-back mold half 11 and the second open-back mold half 12 creates an open void into which the energy from the at least one heating nozzle 20 and the cooling mechanism 30 is focused about the outer shell surface 13.

In further reference to FIG. 1-2, depending on the application of the reduced mass mold 10, the first open-back mold half 11 and the second open-back mold half 12 may further comprise an at least one rib 15. The at least one rib 15 provides added structural stability to the reduced mass mold 10, which is especially beneficial when the reduced mass mold 10 is used for the molding of larger preforms. The at least one rib 15 of the first open-back mold half 11 is adjacently connected to the first cavity shell 111 opposite the cavity mold, wherein the at least one rib 15 of the first open-back mold half 11 and the first lateral wall 110 delineate a plurality of hollow channels 16 in the first open-back mold half 11. Similarly, the at least one rib 15 of the second open-back mold half 12 is adjacently connected to the second cavity shell 121 opposite the cavity mold, wherein the at least one rib 15 of the second open-back mold half 12 and the second lateral wall 120 delineate a plurality of hollow channels 16 in the second open-back mold half 12.

The outer shell surface 13 of the first open-back mold half 11 is accessible by the at least one heating nozzle 20 and the cooling mechanism 30 through the plurality of hollow channels 16 of the first open-back mold half 11. Likewise, the outer shell surface 13 of the second open-back mold half 12 is accessible by the at least one heating nozzle 20 and the cooling mechanism 30 through the plurality of hollow channels 16 of the second open-back mold half 12.

When the reduced mass mold 10 is made from lower thermal conductive materials, such as steel alloy, a material of superior thermal conductivity such as copper or aluminum can be applied to the back of the molding surfaces to further improve the thermal transfer efficiency. Additionally, such materials may be applied to some areas of the reduced mass mold 10 that may not be fully accessible for optimum exposure to the at least one heating nozzle 20. In order to draw heat energy into the less accessible areas or improve the thermal transfer efficiency, the first open-back mold half 11 and the second open-back mold half 12 may further utilize a thermal modification. In one embodiment of the present invention, the thermal modification is a thermal coating 17, such as a plasma sprayed copper coating, wherein the thermal coating 17 is adhered to the outer shell surface 13 of the first cavity shell 111 and/or the outer shell surface 13 of the second cavity shell 121, as depicted in FIG. 3.

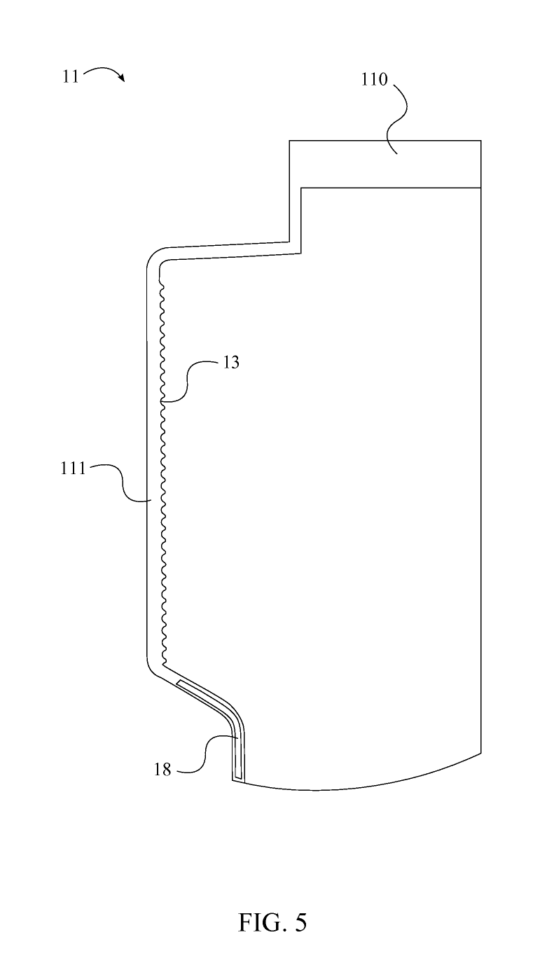

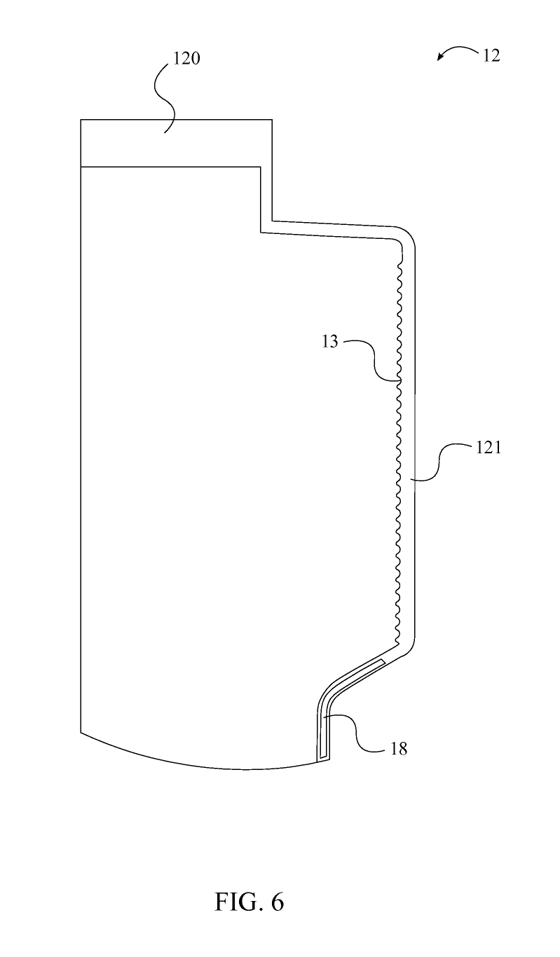

In reference to FIG. 5-6, in another embodiment of the present invention, the first open-back mold half 11 and/or the second open-back mold half 12 further comprises a thermal insert 18. The thermal insert 18 of the first open-back mold half 11 is positioned into the first cavity shell 111, wherein grooves or holes are formed into the first cavity shell 111 for receiving the thermal insert 18 of the first open-back mold half 11. Similarly, the thermal insert 18 of the second open-back mold half 12 is positioned into the second cavity shell 121, wherein grooves or holes are formed into the second cavity shell 121 for receiving the thermal insert 18 of the second open-back mold half 12. Exemplary embodiments of the thermal insert 18 include a copper bar or rod that is positioned into the first cavity shell 111 and/or the second cavity shell 121 to draw heat to remote features.

In further reference to FIG. 5-6, another thermal modification that can be made to the first open-back mold half 11 and the second open-back mold half 12 is the use of a textured or ribbed surface as opposed to a smooth surface. The outer shell surface 13 of the first cavity shell 111 and/or the second cavity shell 121 is textured or ribbed in order to increase the overall surface area of the outer shell surface 13 without adding significant mass to the reduced mass mold 10. The increase in surface area of the outer shell surface 13 enhances the heat transfer by harvesting more heat energy on the input side and transferring the heat energy to the inner mold surface with less surface area. It is anticipated that many patterns, such as concentric grooves or wavy grooves with varying height, can be used to provide optimal thermal transfer to the inner mold surface.

The specific number of the at least one heating nozzle 20 used depends on the size of the reduced mass mold 10 that is to be heated. Preferably, at least two heating nozzles are used, such that the outer shell surface 13 of the first cavity shell 111 and the second cavity shell 121 can be heated simultaneously. If the at least one heating nozzle 20 is specifically one heating nozzle, then the one heating nozzle must be controllable about both sides of the reduced mass mold 10 by the robot or motion control device, or a means must be provided for flipping the reduced mass mold 10.

In the preferred embodiment of the present invention, each of the at least one heating nozzle 20 is a high output gas burner nozzle that produces very high heat output. In other embodiments of the present invention, each of the at least one heating nozzle 20 may provide alternative heating means including, but not limited to, the use of plasma or lasers. The heat energy from each of the at least one heating nozzle 20 is applied to the outer shell surface 13 of the first cavity shell 111 and the second cavity shell 121 in overlapping patterns. The traverse rate, path overlap, and dwell of each of the at least one heating nozzle 20 are manipulated to develop uniform heating about the reduced mass mold 10.

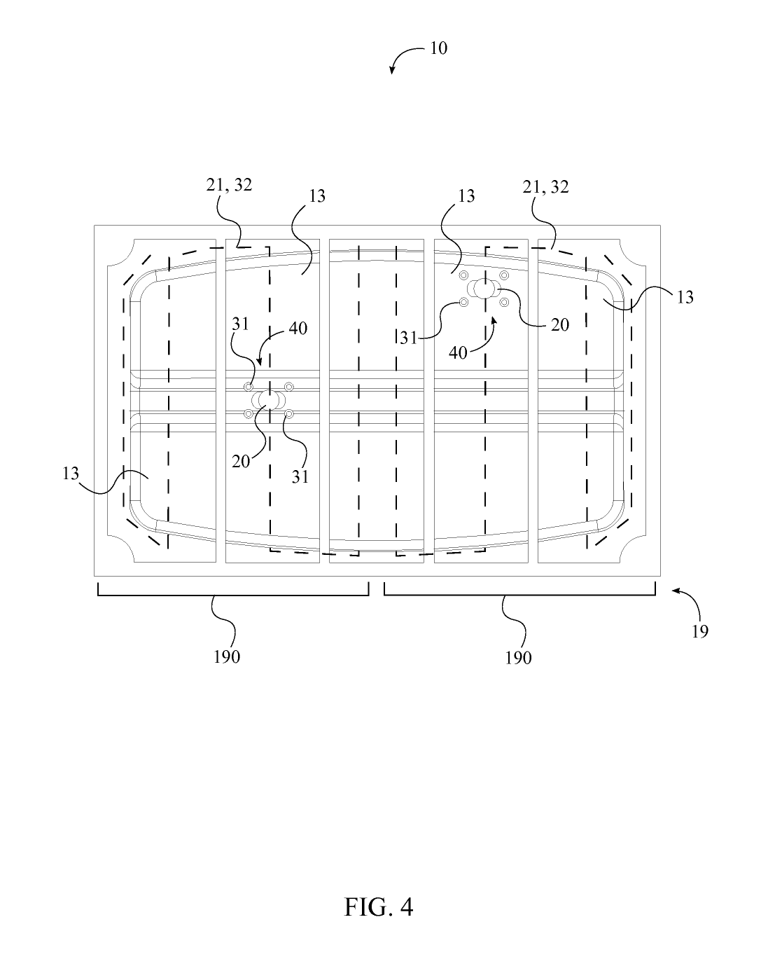

In reference to FIG. 3-4, each of the at least one heating nozzle 20 is navigated about a heating path 21 by the robot or motion control device in order to apply heat to the reduced mass mold 10. The motion of each of the at least one heating nozzle 20 about the heating path 21 can be directed by a preprogrammed open loop pattern or a closed loop control system coupled to temperature feedback sensors monitoring the reduced mass mold 10 surface. The temperature feedback sensors can be thermocouples in the outer shell surface 13, or any other type of sensor capable of providing fast and accurate temperature data. The heating path 21 may form a closed loop, wherein each of the at least one heating nozzle 20 begins applying heat at a starting point and cycles around back to the starting point. Alternatively, the heating path 21 may form an open path, wherein each of the at least one heating nozzle 20 begins applying heat at a starting point, traverses to an end point, and then reverses direction back to the starting point. The heating path 21 for each of the at least one heating nozzle 20 may be any combination of planned or controlled moves and jumps in order to achieve even heating of the outer shell surface 13.

In reference to FIG. 4, the reduced mass mold 10 may be partitioned into a plurality of zones 19 depending of the thermal load and the desired cycle time. The plurality of zones 19 is spatially positioned about the reduced mass mold 10, wherein each of the at least one heating nozzle 20 is designated to a specific zone 190 from the plurality of zones 19. Each of the plurality of zones 19 is controlled independently, wherein the heating path 21 may vary for each of the plurality of zones 19. In this way, the control of each of the at least one heating nozzle 20 can be sequenced in ways that benefit the process conditions desired for the specific application of the present invention. For example, it may be beneficial to heat the reduced mass mold 10 from the middle towards the ends of the reduced mass mold 10 to control thermal expansion of the reduced mass mold 10.

The heating path 21 of each of the at least one heating nozzle 20 can be one dimensional, two dimensional, or three dimensional depending on the application of the present invention. As such, each of the at least one heating nozzle 20 has at least one degree of freedom. For example, each of the at least one heating nozzle 20 would be manipulated about a x-axis, a y-axis, and a z-axis for the reduced mass mold 10 requiring the heating path 21 to be three dimensional as depicted in FIG. 3-4. Movement about the x-axis, the y-axis, and the z-axis is coordinated with the heating path 21 to maintain a desired offset from the outer shell surface 13 while traversing about the first cavity shell 111 and the second cavity shell 121. The coordinated movement is a “spray painting like” motion with rate and overlap used to deliver a uniform heat input across the outer shell surface 13.

The cooling mechanism 30 is preferably an at least one cooling nozzle 31. Each of the at least one cooling nozzle 31 diffuses a cooling fluid about the outer shell surface 13 of the first cavity shell 111 and the second cavity shell 121 in overlapping patterns in order to cool the reduced mass mold 10. Similar to the at least one heating nozzle 20, the traverse rate, path overlap, and dwell of each of the at least one cooling nozzle 31 are manipulated to develop uniform cooling about the reduced mass mold 10. The cooling fluid can be air, water, a fluid blend of air and water, or any other suitable fluid.

The specific number of the at least one cooling nozzle 31 used depends on the size of the reduced mass mold 10 that is to be cooled. Preferably, at least two cooling nozzles are used, such that the outer shell surface 13 of the first cavity shell 111 and the second cavity shell 121 can be cooled simultaneously. If the at least one cooling nozzle 31 is specifically one cooling nozzle, then the one cooling nozzle must be controllable about both sides of the reduced mass mold 10 by the robot or motion control device, or a means must be provided for flipping the reduced mass mold 10.

In reference to FIG. 3-4, each of the at least one cooling nozzle 31 is navigated about a cooling path 32 by the robot or motion control device in order to apply the cooling fluid to the reduced mass mold 10. The motion of each of the at least one cooling nozzle 31 about the cooling path 32 can be directed by a preprogrammed open loop pattern or a closed loop control system coupled to temperature feedback sensors monitoring the reduced mass mold 10 surface. The temperature feedback sensors can be thermocouples in the outer shell surface 13, or any other type of sensor capable of providing fast and accurate temperature data.

The cooling path 32 may form a closed loop, wherein each of the at least one cooling nozzle 31 begins applying heat at a starting point and cycles around back to the starting point. Alternatively, the cooling path 32 may form an open path, wherein each of the at least one cooling nozzle 31 begins applying heat at a starting point, traverses to an end point, and then reverses direction back to the starting point. The cooling path 32 for each of the at least one cooling nozzle 31 may be any combination of planned or controlled moves and jumps in order to achieve even cooling of the outer shell surface 13.

Similar to the heating path 21 and in reference to FIG. 4, if the plurality of zones 19 is implemented, then the cooling path 32 may vary for each of the plurality of zones 19. In this way, the control of each of the at least one cooling nozzle 31 can be sequenced in ways that benefit the process conditions desired for the specific application of the present invention. For example, it may be beneficial to cool the reduced mass mold 10 from the ends of the reduced mass mold 10 towards the middle to control thermal expansion of the reduced mass mold 10.

The cooling path 32 of each of the at least one cooling nozzle 31 can be one dimensional, two dimensional, or three dimensional depending on the application of the present invention. As such, each of the at least one cooling nozzle 31 has at least one degree of freedom. For example, each of the at least one cooling nozzle 31 would be manipulated about a x-axis, a y-axis, and a z-axis for the reduced mass mold 10 requiring the cooling path 32 to be three dimensional as depicted in FIG. 3-4. Movement about the x-axis, the y-axis, and the z-axis is coordinated with the cooling path 32 to maintain a desired offset from the outer shell surface 13 while traversing about the first cavity shell 111 and the second cavity shell 121. The coordinated movement is a “spray painting like” motion with rate and overlap used to deliver a uniform distribution of the cooling fluid about the outer shell surface 13.

In some embodiments of the present invention, an at least one nozzle assembly 40 is provided for both heating and cooling the reduced mass mold 10 in the same station, as depicted in FIG. 1-4. As such, each of the at least one nozzle assembly 40 comprises at least one heating nozzle 20 and at least one cooling nozzle 31. In this way, the number of robots or motion control devices can be reduced, which in turn reduces the manufacturing space required and equipment costs. Similar to the nozzle configurations previously described, the specific number of the at least one nozzle assembly 40 used depends on the size of the reduced mass mold 10 that is to be heated and cooled, wherein at least two nozzle assemblies are preferably used, such that the outer shell surface 13 of the first cavity shell 111 and the second cavity shell 121 can be heated and cooled simultaneously.

Each of the at least one nozzle assembly 40 is first navigated along the heating path 21 and then the cooling path 32 by the robot or motion control device in order to heat and cool the reduced mass mold 10 respectively. The motion of each of the at least one nozzle assembly 40 about the heating path 21 and the cooling path 32 can be directed by a preprogrammed open loop pattern or a closed loop control system coupled to temperature feedback sensors monitoring the reduced mass mold 10 surface. The temperature feedback sensors can be thermocouples in the outer shell surface 13, or any other type of sensor capable of providing fast and accurate temperature data.

If the plurality of zones 19 is implemented, then the control of each of the at least one nozzle assembly 40 is independent and can be sequenced in ways that benefit the process conditions desired for the specific application of the present invention. Each of the at least one nozzle assembly 40 has at least one degree of freedom. For example, each of the at least one nozzle assembly 40 would be manipulated about a x-axis, a y-axis, and a z-axis for the reduced mass mold 10 requiring the heating path 21 or the cooling path 32 to be three dimensional as depicted in FIG. 3-4. Movement about the x-axis, the y-axis, and the z-axis is coordinated with the heating path 21 or the cooling path 32 to maintain a desired offset from the outer shell surface 13 while traversing about the first cavity shell 111 and the second cavity shell 121.

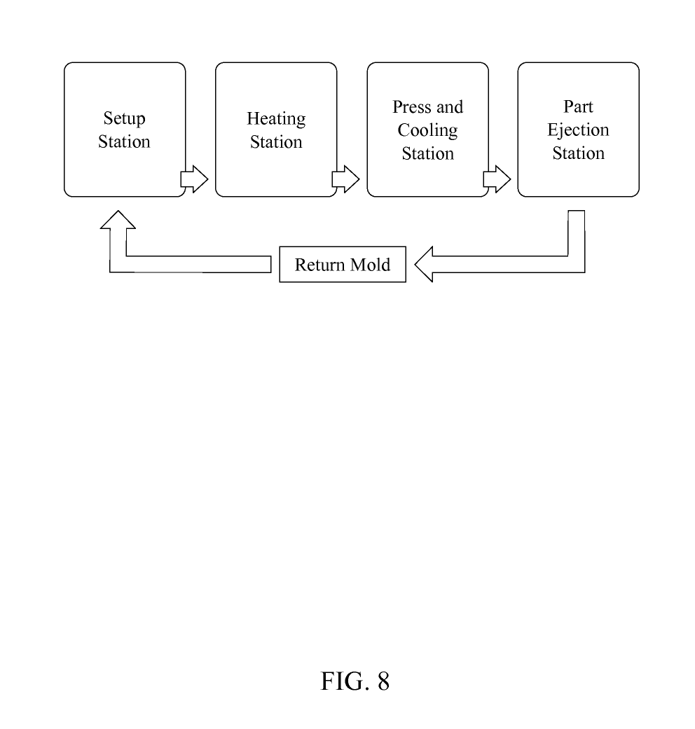

The method of the present invention provides a means for high volume thermoplastic composite molding applications. In reference to FIG. 8, in the preferred embodiment of the present invention, the process is divided into four work stations; a setup station, a heating station (or gas burner station), a press and cooling station, and a part ejection station. The methods of material handling, mold handling, mold transfer, and other operations described can be carried out manually, be automated using robots or motion control devices and dedicated specially designed equipment, or a combination of both. The choice of the level of specialization and automation would be determined by the business case for the project or product being produced.

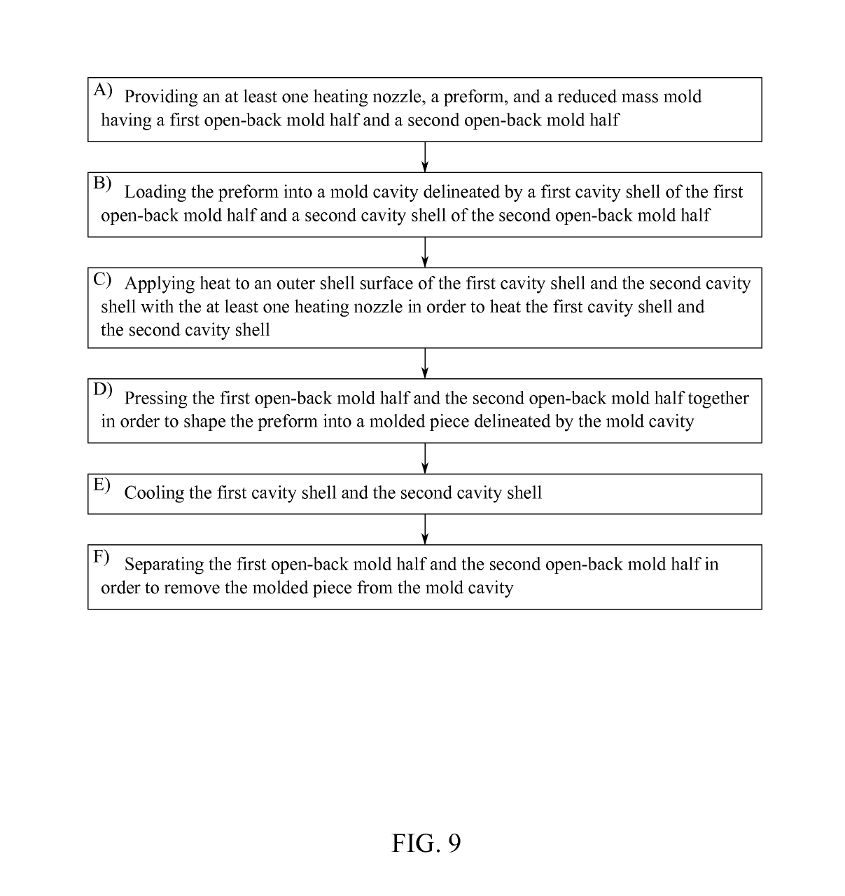

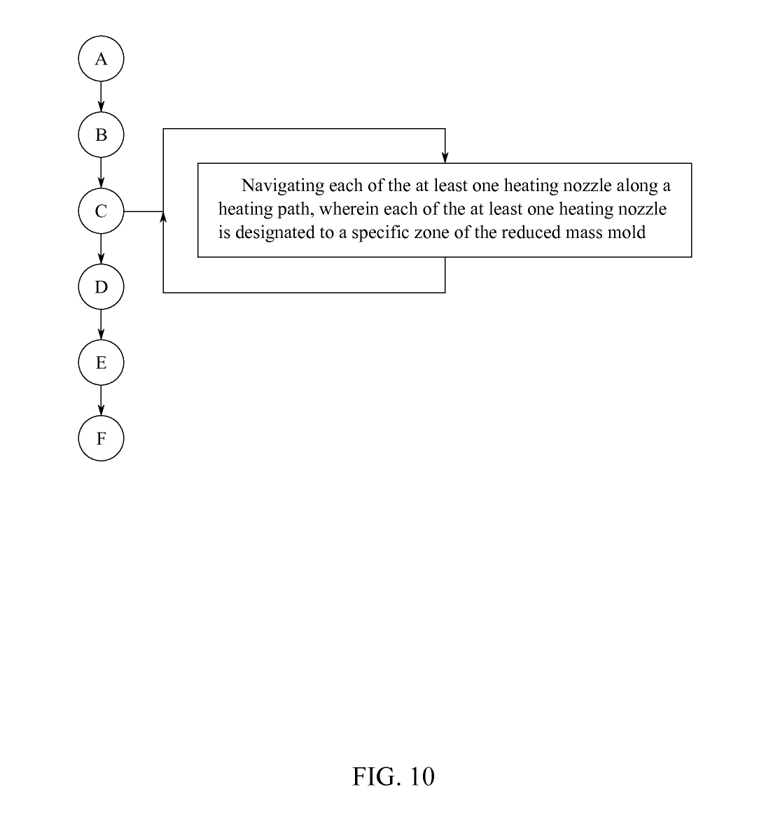

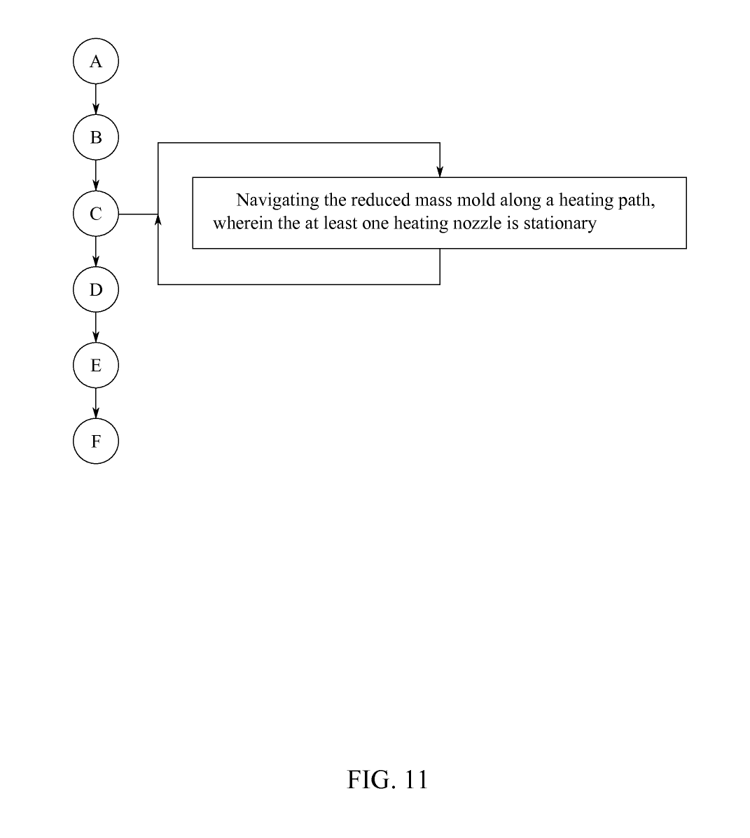

In reference to FIG. 8-9, the preform 50 is first loaded into the cavity mold of the reduced mass mold 10 at the setup station, wherein the first open-back mold half 11 and the second open-back mold half 12 are secured together encasing the preform 50. The reduced mass mold 10 is then transferred to the heating station, wherein heat is applied to the outer shell surface 13 of the first cavity shell 111 and the second cavity shell 121 using the at least one heating nozzle 20 in order to heat the first cavity shell 111 and the second cavity shell 121. In reference to FIG. 10, in the preferred embodiment of the present invention, each of the at least one heating nozzle 20 is articulated about the reduced mass mold 10, while the reduced mass mold 10 remains stationary. In reference to FIG. 11, in an alternative embodiment of the present invention, the at least one heating nozzle 20 remains stationary, while the reduced mass mold 10 is navigated along the heating path 21.

Conductive heat flows away from the at least one heating nozzle 20 and the rate the conductive heat flows is proportional to the temperature difference; the greater the difference, the faster the conductive heat flows. The principles of heat flux as practiced in the present invention are defined by Fourier's Law and the application of those principles are well known by those of ordinary skill and knowledge of heating and cooling systems design. A function of the present invention is the creation of a very large temperature difference between the outer shell surface 13 and the inner mold surface. The preferred method is to use a gas fed burner with output temperatures of greater than 1,300° C. Natural gas or propane burners have flame temperatures of 1,300° C. to greater than 2,95020 C. depending on design and fuel air mixture. The size of the energy output should be sized to the application of the present invention. The output of each burner nozzle is generally between 40,000 and 300,000 BTU/H but can be more or less depending on the application, mold size, and desired cycle times of the present invention. Other devices such as plasma or laser cutters could serve as a heat source in place of the gas burners.

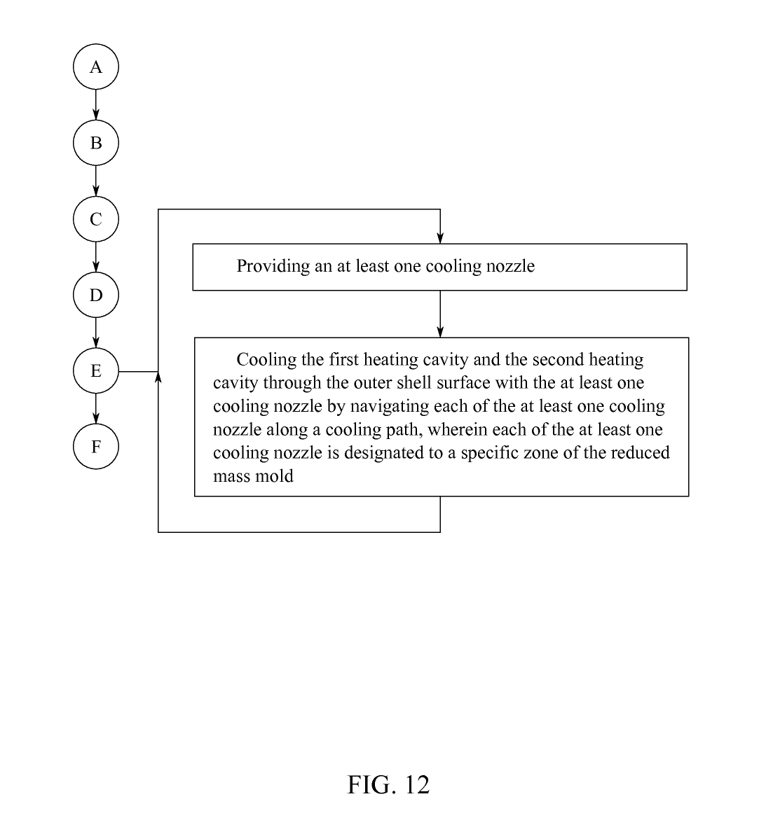

In reference to FIG. 8-9, once the reduced mass mold 10 is heated to the process temperature, the reduced mass mold 10 is transferred to the press and cooling station. At the press and cooling station, the first open-back mold half 11 and the second open-back mold half 12 are pressed together in order to shape the preform 50 into the molded piece 60 delineated by the mold cavity 14. As the first open-back mold half 11 and the second open-back mold half 12 are pressed together, the cooling mechanism 30 is utilized to cool the first cavity shell 111 and the second cavity shell 121. In reference to FIG. 12, in the preferred embodiment of the present invention, the cooling mechanism 30 is the at least one cooling nozzle 31, wherein each of the at least one cooling nozzle 31 is articulated about the reduced mass mold 10, while the reduced mass mold 10 remains stationary.

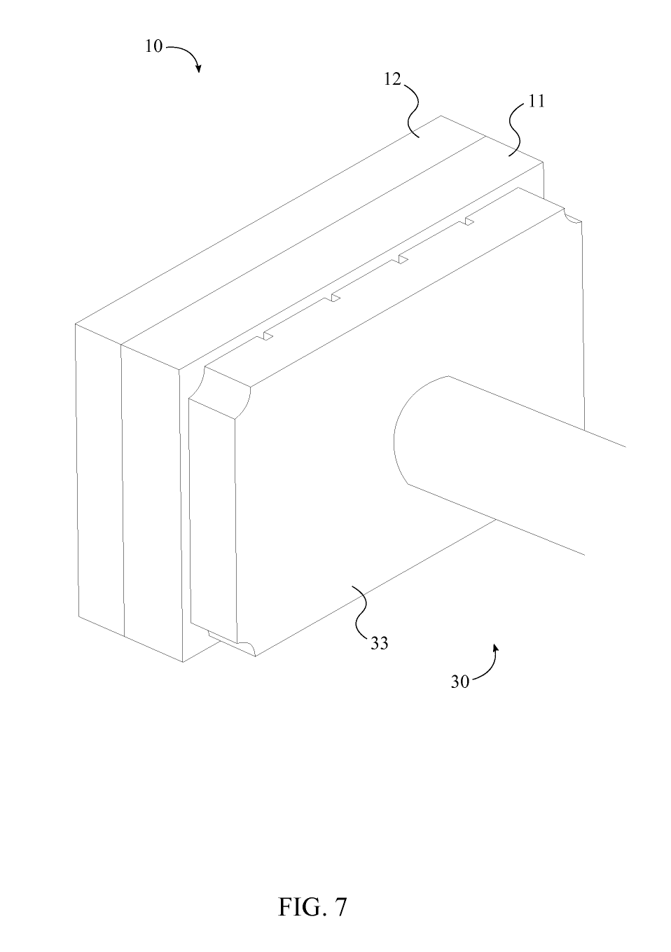

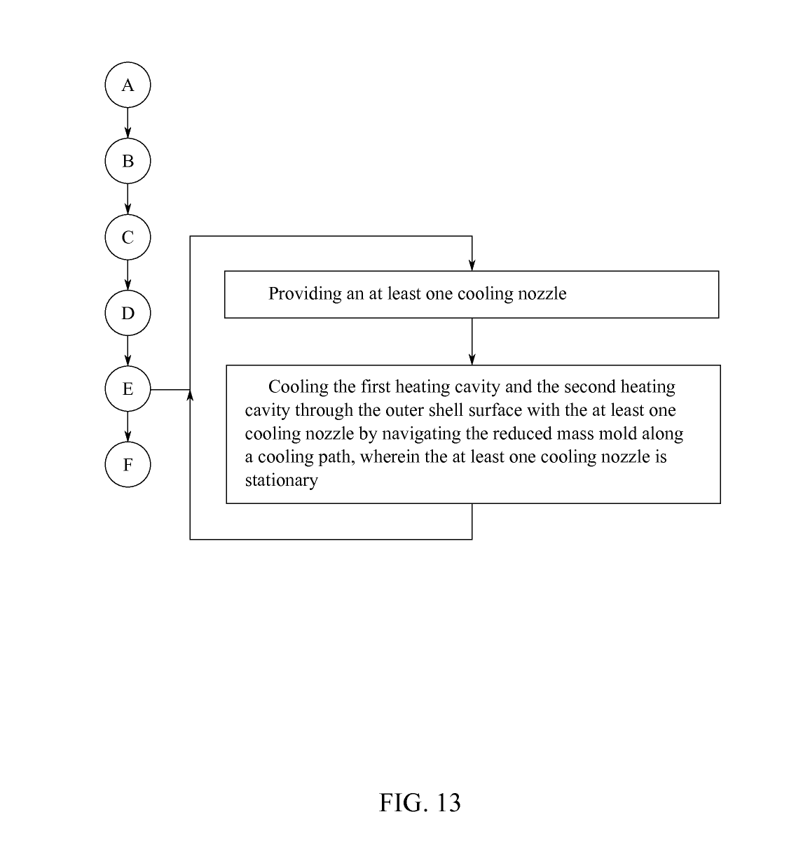

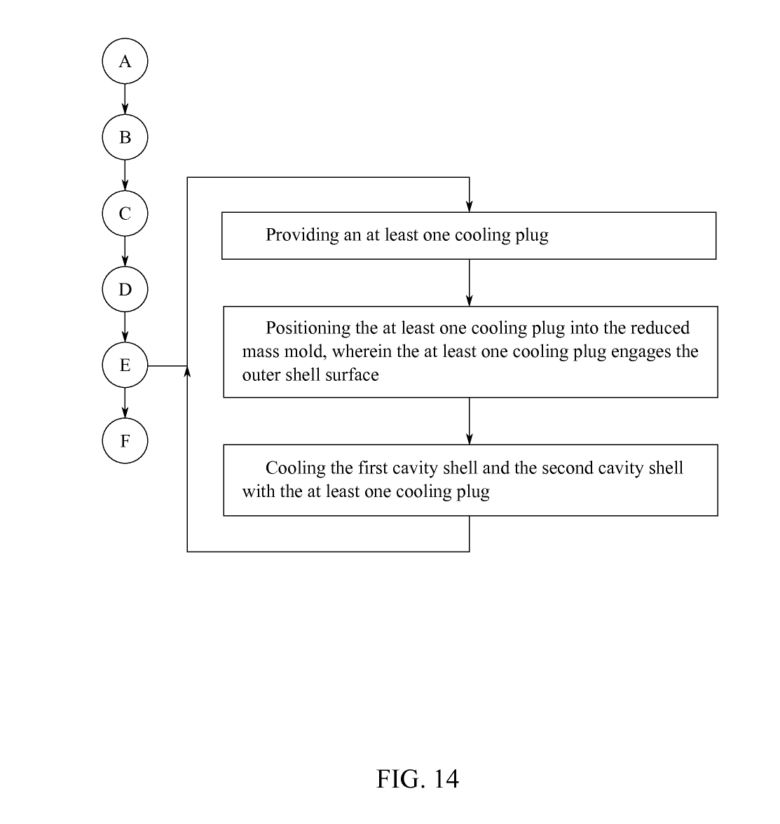

In reference to FIG. 13, in an alternative embodiment of the present invention, the at least one cooling nozzle 31 remains stationary, while the reduced mass mold 10 is navigated along the cooling path 32. In reference to FIG. 7 and FIG. 14, in yet another embodiment of the present invention, the cooling mechanism 30 is an at least one cooling plug 33. The at least one cooling plug 33 is positioned into the reduced mass mold 10, wherein the at least one cooling plug 33 engages the outer shell surface 13. More specifically, the at least one cooling plug 33 is positioned into the void or the plurality of hollow channels 16 of the first open-back mold half 11 and the second open-back mold half 12. The first cavity shell 111 and the second cavity shell 121 are then cooled through sustained contact with the at least one cooling plug 33. Preferably, at least two cooling plugs are used, such that the outer shell surface 13 of the first cavity shell 111 and the second cavity shell 121 can be cooled simultaneously.

In reference to FIG. 8-9, once the reduced mass mold 10 has cooled to the prescribed temperature, the reduced mass mold 10 is transferred to the part ejection station. At the part ejection station, the first open-back mold half 11 is separated from the second open-back mold half 12 in order to remove the molded piece 60 from the mold cavity 14. The molded piece 60 is then removed from the mold cavity 14, and the reduced mass mold 10 is returned to the setup station to be loaded with a subsequent preform 50, wherein the molding process is repeated for the subsequent preform 50. It is to be noted that if the at least one nozzle assembly 40 is utilized, the heating station and the press and cooling station are to be combined into a single station.

The advantages of the present invention include, without limitation, a method to heat and cool complex molds both large and small using the at least one heating nozzle 20 and the at least one cooling nozzle 31. This is accomplished with simple changes in the motion control system, setting the heating path 21 and the cooling path 32 of each of the at least one heating nozzle 20 and each of the at least one cooling nozzle 31, respectively, to the needs of the reduced mass mold 10 to be utilized. Having the heat input and the cooling mechanism 30 separate from the reduced mass mold 10 reduces the cost of future mold sets as those cost are not required. It is also obvious that by decoupling the steps in the process, such as the heating and cooling steps, it is possible to further reduce cycle times with multiple molds running in series through a specialized molding system.

While the foregoing written description of the present invention enables one of ordinary skill to make and use what is considered presently to be the best mode thereof, those of ordinary skill will understand and appreciate the existence of variations, combinations, and equivalents of the specific embodiment, method, and examples herein. The present invention should therefore not be limited by the above described embodiment, method, and examples, but by all embodiments and methods within the scope and spirit of the invention.

Although the invention has been explained in relation to its preferred embodiment, it is to be understood that many other possible modifications and variations can be made without departing from the spirit and scope of the invention as hereinafter claimed.

What is claimed is:

1. An articulated impingement mold heating system comprises:
a reduced mass mold having a first open-back mold half and a second open-back mold half;
an at least one nozzle assembly;
each of the at least one nozzle assembly comprises an at least one heating nozzle;
the first open-back mold half comprises a first cavity shell;
the second open-back mold half comprises a second cavity shell;
both the first cavity shell and the second cavity shell having an outer shell surface;
the first open-back mold half being positioned adjacent to the second open-back mold half;
the first cavity shell and the second cavity shell delineating a mold cavity;
the outer shell surface of the first cavity shell being positioned about the first cavity shell opposite the mold cavity;
the outer shell surface of the second cavity shell being positioned about the second cavity shell opposite the mold cavity; and
the at least one heating nozzle being positioned adjacent to the outer shell surface, wherein each of the at least one heating nozzle is movable along a heating path.

2. The articulated impingement mold heating system as claimed in claim 1 further comprises:
each of the at least one nozzle assembly further comprises an at least one cooling nozzle; and
the at least one cooling nozzle being positioned adjacent to the outer shell surface, wherein each of the at least one cooling nozzle is movable along a cooling path.

3. The articulated impingement mold heating system as claimed in claim 1 further comprises:
a plurality of zones being spatially positioned about the reduced mass mold; and
each of the at least one nozzle assembly being positioned in a specific zone from the plurality of zones.

4. The articulated impingement mold heating system as claimed in claim 1 further comprises:
the first open-back mold half further comprises an at least one rib;
the at least one rib being adjacently connected to the first cavity shell opposite the mold cavity; and
the at least one rib delineating a plurality of hollow channels in the first open-back mold half.

5. The articulated impingement mold heating system as claimed in claim 1 further comprises:
the second open-back mold half further comprises an at least one rib;
the at least one rib being adjacently connected to the second cavity shell opposite the mold cavity; and
the at least one rib delineating a plurality of hollow channels in the second open-back mold half.

6. The impingement heating mold as claimed in claim 1 further comprises:
a thermal coating being adhered to the outer shell surface of the first cavity shell.

7. The impingement heating mold as claimed in claim 1 further comprises:
a thermal coating being adhered to the outer shell surface of the second cavity shell.

8. The impingement heating mold as claimed in claim 1 further comprises:
the first open-back mold half further comprises a thermal insert; and
the thermal insert being positioned into the first cavity shell.

9. The impingement heating mold as claimed in claim 1 further comprises:
the second open-back mold half further comprises a thermal insert; and
the thermal insert being positioned into the second cavity shell.

10. The impingement heating mold as claimed in claim 1, wherein the outer shell surface of the first cavity shell is textured.

11. The impingement heating mold as claimed in claim 1, wherein the outer shell surface of the second cavity shell is textured.

12. A method for articulated impingement mold heating comprises the steps of:
providing an at least one heating nozzle, a preform, and a reduced mass mold having a first open-back mold half and a second open-back mold half;
loading the preform into a mold cavity delineated by a first cavity shell of the first open-back mold half and a second cavity shell of the second open-back mold half;
applying heat to an outer shell surface of the first cavity shell and the second cavity shell with the at least one heating nozzle in order to heat the first cavity shell and the second cavity shell;
pressing the first open-back mold half and the second open-back mold half together in order to shape the preform into a molded piece delineated by the mold cavity;
cooling the first cavity shell and the second cavity shell; and
separating the first open-back mold half and the second open-back mold half in order to remove the molded piece from the mold cavity.

13. The method for articulated impingement mold heating as claimed in claim 12 further comprises the steps of:
navigating each of the at least one heating nozzle along a heating path.

14. The method for articulated impingement mold heating as claimed in claim 13, wherein each of the at least one heating nozzle is designated to a specific zone of the reduced mass mold.

15. The method for articulated impingement mold heating as claimed in claim 12 further comprises the steps of:
navigating the reduced mass mold along a heating path, wherein the at least one heating nozzle is stationary.

16. The method for articulated impingement mold heating as claimed in claim 12 further comprises the steps of:
providing an at least one cooling nozzle; and
cooling the first heating cavity and the second heating cavity through the outer shell surface with the at least one cooling nozzle.

17. The method for articulated impingement mold heating as claimed in claim 16 further comprises the steps of:
navigating each of the at least one cooling nozzle along a cooling path.

18. The method for articulated impingement mold heating as claimed in claim 17, wherein each of the at least one cooling nozzle is designated to a specific zone of the reduced mass mold.

19. The method for articulated impingement mold heating as claimed in claim 16 further comprises the steps of:
navigating the reduced mass mold along a cooling path, wherein the at least one cooling nozzle is stationary.

20. The method for articulated impingement mold heating as claimed in claim 12 further comprises the steps of:
providing an at least one cooling plug;
positioning the at least one cooling plug into the reduced mass mold, wherein the at least one cooling plug engages the outer shell surface; and
cooling the first cavity shell and the second cavity shell with the at least one cooling plug.
